(19) United States
(12) Patent Application Publication
(10) Pub. No.: US 2001/0006546 A1
(43) Pub. Date: Jul. 5, 2001

(54) Apparatus and method for automatically setting a vibration mode in a mobile terminal

(76) Inventor: Byeng-Sang Jung, Suwon-shi (KR)

Correspondence Address: Paul J. Farrell, Esq., DILWORTH & BARRESE, 333 Earle Ovington Boulevard, Uniondale, NY, 11553, US

(21) Appl. No.: 09/737,136

(22) Filed: Dec. 14, 2000

(30) Foreign Application Priority Data
Dec. 31, 1999 (KR) 68159/1999

(51) Int. Cl. H04Q 7/20

(52) U.S. Cl. 379/56.3; 455/567; 455/458

(57) ABSTRACT

An apparatus and method for automatically setting a vibration mode of a mobile terminal using infrared signals and a method therefor. The apparatus determines whether or not the infrared signals are inputted by an infrared signal receiving section. A data content of received infrared signals is interpreted by a control section. The control section then switches the mobile terminal between a vibration mode and a previous incoming call mode according to the resultant interpretation of the data content. Accordingly, a mobile phone may be placed in a vibration mode automatically upon entering a public place requiring silence, and may be switched back to the previous incoming call receiving mode upon exiting the public place.

### PRIORITY

This application claims priority to an application entitled “Apparatus For Setting a Vibration Mode By Receiving Infrared Rays Of Mobile Terminal Equipment And Method Therefor” filed in the Korean Industrial Property Office on Dec. 31, 1999 and assigned Ser. No. 68159/1999, the contents of which are hereby incorporated by reference.

### BACKGROUND OF THE INVENTION

1. Field of the Invention

The present invention relates generally to an apparatus and method for automatically controlling a vibration mode in a mobile terminal, and more particularly to an apparatus and method for automatically converting the mobile terminal to a vibration mode using infrared signals.

2. Description of the Related Art

As mobile terminal usage continues to increase sharply, more and more people are troubled by noise disruptions caused by incoming calls received at inappropriate times, or in inappropriate places. In particular, incoming call ringing has become one of the main causes of disruptive noises in public places requiring more silence, e.g., public performance halls, lecture halls, subways, buses, etc.

To reduce the disruptive noise generated due to incoming calls in mobile terminals in public places requiring more silence, a user is required to manually convert a call receiving mode of the mobile terminal to a vibration mode or to turn off the mobile terminal before entering the place. However, such measures inconveniently require a user's assistance. A method and apparatus is therefore needed which advantageously automatically controls the receiving mode of a mobile terminal, without relying on user intervention.

### SUMMARY OF THE INVENTION

It is therefore an object of the present invention to provide an apparatus for controlling automatic conversion of an incoming call receiving mode of a mobile terminal to a vibration mode when a user enters public places requiring silence and a method thereof.

It is another object of the present invention to provide an apparatus for automatically setting a vibration mode of the mobile terminal using infrared signals.

To achieve the above objects, the apparatus for setting the vibration mode of the mobile terminal, and a method thereof, determines whether or not infrared signals are received via an infrared signal receiving section. The data content of received infrared signals is interpreted by a control section. The control section then switches the mobile terminal between a vibration mode and a previous incoming call receiving mode according to the data content.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a location of infrared signal transmitting devices in accordance with the present invention;

FIG. 2 is a block diagram illustrating the infrared signal transmitting device and a mobile terminal in accordance with the present invention; and

FIG. 3 is a flow chart illustrating a method for automatically setting a vibration mode in a mobile terminal in accordance with the present invention.

### DETAILED DESCRIPTION OF THE PREFERRED EMBODIMENT

A preferred embodiment of the present invention will be described hereinbelow with reference to the accompanying drawings. In the following description, like reference numerals identify similar or identical elements throughout the drawings.

In the following description, well-known functions or constructions are not described in detail since they would obscure the invention in unnecessary detail.

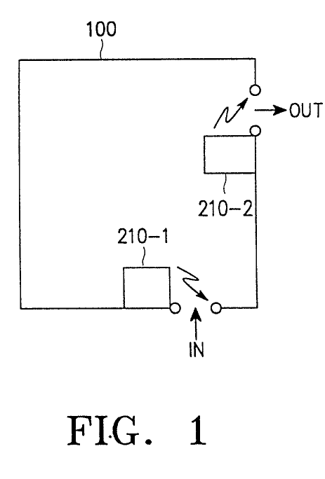

FIG. 1 is a diagram illustrating an exemplary location of infrared signal transmitting devices in accordance with the present invention, to operate an apparatus for automatically setting a vibration mode of a mobile terminal.

Referring to FIG. 1, there are infrared signal transmitting devices 210-1 and 210-2 are installed near an entrance and an exit, respectively, of a specific place 100 requiring silence. The infrared signal transmitting devices continuously transmit infrared signals at a predetermined wavelength and protocol. The infrared signal transmitting device installed at the entrance includes instruction data in its transmitted infrared signals to convert an incoming call receiving mode to a vibration mode of the mobile terminal. The infrared signal transmitting device 210-2 installed at the exit includes instruction data in its transmitted infrared rays to return the mobile terminal from the vibration mode to the previous call receiving mode of the mobile terminal. While an exemplary layout is illustrated as a preferred embodiment, it is understood by those skilled in the art that devices 210-1 and 210-2 may be installed in various configurations and in various places, including airplanes, buses, etc.

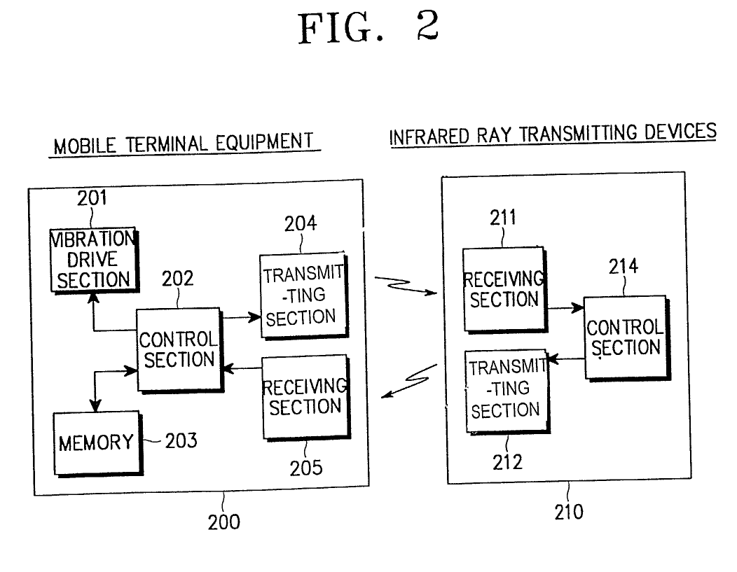

FIG. 2 is a block diagram illustrating the infrared signal transmitting device and the mobile terminal.

Referring to FIG. 2, the mobile terminal 200 in accordance with the present invention and the infrared signal transmitting devices 210-1, 210-2 installed at the entrance and the exit as shown in FIG. 1 is shown, including infrared transmitting and receiving sections. The mobile terminal 200 includes a transmitting section 204 that transmits infrared rays, including request signals, according to the predetermined wavelength and protocol under the control of a control section 202. The transmitting section 204 is optional, for efficient communication setup or for transmitting data to the infrared signal transmitting devices 210-1, 210-2. A receiving section 205 is used for receiving infrared signals transmitted from the infrared signal transmitters 210-1, 210-2, including instruction data for conversion to the vibration mode or for return to the original incoming call receiving mode. The transmitting section 204 and receiving section 205 is preferably installed within the mobile terminal 200. A control section 202 controls an overall operation of setting the vibration mode in accordance with the present invention. The control section 202 interprets instruction data in the infrared signals received by the receiving section 205 and determines whether or not there is a request for conversion to the vibration mode or for a return to the original incoming call receiving mode, so as to control conversion to and from the vibration mode according to the resultant interpretation. A vibration drive section 201 generates a vibration when an incoming call is received under the control of the control section 202. The vibration drive section 201 includes a motor and controls the drive of the motor in general. A memory 203 stores a program to drive the control section 202 and temporarily stores the previous incoming call receiving mode when there is a request for conversion to the vibration mode under the control of the control section 202. Here, the previous incoming call receiving mode is temporarily stored in memory 203 so as to return to the original incoming call receiving mode.

The transmitting devices 210 installed at the entrance and exit of the specific place preferably continuously transmit infrared signals of a predetermined wavelength and protocol, but may also do so periodically. The transmitted signals include instruction data to instruct the mobile terminal to convert from the incoming call receiving mode to the vibration mode, and instruction signals to instruct the mobile terminal to return to the previous incoming call receiving mode (as stored in the memory 203). The infrared signals are transmitted by the transmitting section 212 under the control of the control section 214. The receiving section 211 receives additional optional infrared signals transmitted by the mobile terminal. The receiving section 211 is therefore optional itself, but is useful for efficient communication setup and monitoring the condition of the mobile terminal.

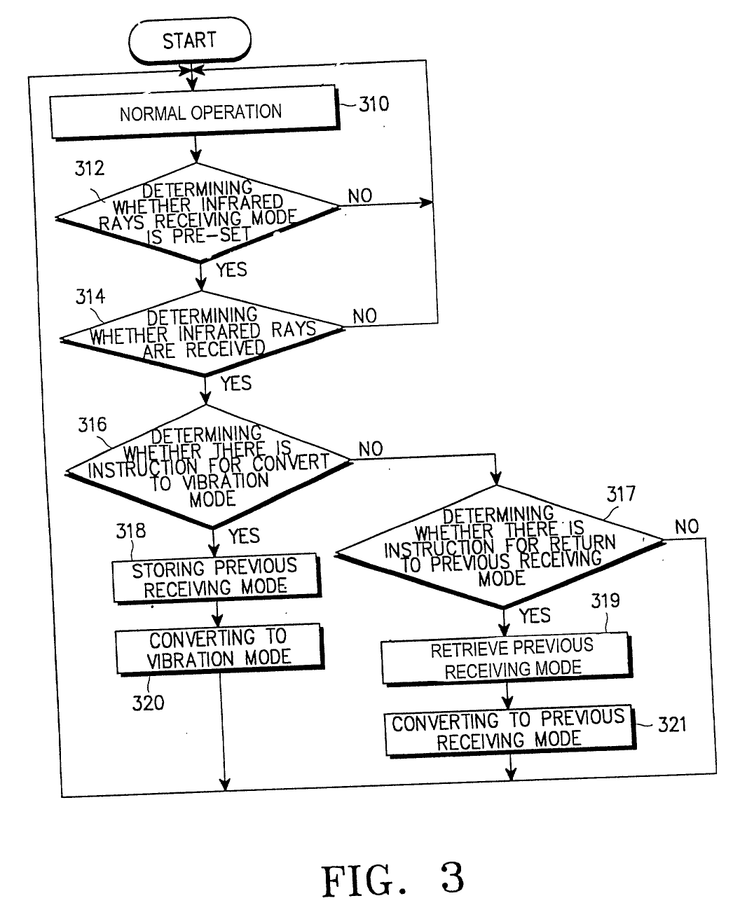

FIG. 3 is a flow chart illustrating a method for automatically setting the vibration mode in accordance with the present invention. Referring to FIG. 3, the mobile terminal operates normal procedures in step 310. The mobile terminal's control section 202 determines whether or not the infrared signal receiving mode is pre-set to accept the infrared signals in step 312. The infrared ray receiving mode is selectively set by either the manufacturer or the user. If the infrared ray receiving mode is set, it is determined by the control section 202 whether or not infrared signals are received by the receiving section 205 in step 314. In the affirmative, it is determined whether or not the received infrared signals include data instructing the mobile terminal to convert to the vibration mode in step 316. In the affirmative, that is, when the mobile terminal enters an entrance at which an infrared signal transmitting device 210-1 is installed, a previous incoming call receiving mode is temporarily stored in the memory 203 in step 318. Here, the previous incoming call receiving mode is an incoming call receiving mode previously selected by a user of the mobile terminal. The incoming call receiving mode is then converted to the vibration mode by the control section 202 in step 320. If an incoming call is received after step 320, the mobile terminal does not generate an incoming call ringing alert, but generates a vibration alert instead.

However, if the received infrared signals do not include data instructing the control section 202 to switch the mobile terminal to the vibration mode in step 316, it is determined whether or not the received infrared signals include data instructing the mobile terminal to return to the previous incoming call receiving mode. In the affirmative, that is, when the mobile terminal exits the exit at which an infrared signal transmitting device 210-2 is installed, the stored previous receiving mode is retrieved from memory 203 by the control section 202 in the step 319. The retrieved previous receiving mode then becomes the incoming call receiving mode again. In other words, the mode of the mobile terminal is switched back to the previous incoming call receiving mode by the control section 202 in step 321. If incoming calls are received after step 321, the mobile terminal generates an incoming call ringing or a vibration according to the incoming call receiving mode previously selected by the user prior to entering the specific place.

As stated above, the present invention has an advantage of eliminating disruptive noise caused by incoming call ringing in inappropriate places. The present invention has another advantage of easily eliminating noise by using infrared signals without requiring additional large scale equipment.

While the invention has been shown and described with reference to a certain preferred embodiment thereof, it will be understood by those skilled in the art that various changes in form and details may be made therein without departing from the spirit and scope of the invention as defined by the appended claims. For example, while the invention is shown and described using infrared signal communication, other known close proximity communication methods and/or protocols may be used, including a low power RF signaling scheme.

What is claimed is:

1. An apparatus for controlling a vibration mode of a mobile terminal, the apparatus comprising:
a receiving section for receiving infrared signals transmitted from an infrared source;
a control section for determining whether or not the received infrared signals include data instructing the mobile terminal to switch to a vibration mode or to return to a previous incoming call receiving mode, and for switching the mode of the mobile terminal according to the data; and
a vibration drive section for vibrating the mobile terminal under the control of the control section when an incoming call is received while the mobile terminal is in the vibration mode.

2. The apparatus claimed in claim 1, wherein the control section stores a previous incoming call receiving mode identifier in a memory prior to switching to the vibration mode and retrieves the stored previous incoming call mode identifier from the memory when switching to the previous incoming call receiving mode.

3. The apparatus as claimed in claim 1, wherein the infrared source is at least one infrared signal transmitting device installed at entrance and exit locations and the data received in the infrared signals is received from a corresponding one of the infrared signal transmitting devices, said data instructing the mobile terminal to switch between the vibration mode and the previous incoming call receiving mode according to the location of the corresponding one of the infrared signal transmitting devices.

4. A method of automatically setting a vibration mode in a mobile terminal, said mobile terminal comprising an infrared signal for receiving infrared signals from an infrared source and a controller for switching a call receiving mode according to the received infrared signals, said method comprising the steps of:
determining whether or not the infrared signals are received by the infrared signal receiving section;
interpreting a data content of any received infrared signals; and
switching the incoming call receiving mode to a vibration mode or a previous incoming call receiving mode according to the data content.

5. The method as claimed in claim 4, wherein the step of switching the incoming call receiving mode includes substeps of storing a previous incoming call receiving mode identifier in a memory when switching to the vibration mode, and retrieving the stored previous incoming call receiving mode identifier from the memory when switching to the previous incoming call receiving mode.

6. The method of claim 4, wherein the infrared source is at least one infrared signal transmitting device installed at entrance and exit locations and the data received in the infrared signals is received from a corresponding one of the infrared signal transmitting devices, said data instructing the mobile terminal to switch between the vibration mode and the previous incoming call receiving mode according to the location of the corresponding one of the infrared signal transmitting devices.

7. The method as claimed in claim 6, further comprising the steps of:
transmitting acknowledgment infrared signals from the mobile terminal to a receiving section of each one of the at least one infrared transmitting device to establish communication therewith.

8. An apparatus for controlling a vibration mode of a mobile terminal, the apparatus comprising:
a receiving section for receiving low power RF signals transmitted from a low power RF source;
a control section for determining whether or not the received low power RF signals include data instructing the mobile terminal to switch to a vibration mode or to return to a previous incoming call receiving mode, and for switching the mode of the mobile terminal according to the data; and
a vibration drive section for vibrating the mobile terminal under the control of the control section when an incoming call is received while the mobile terminal is in the vibration mode.

9. The apparatus claimed in claim 8, wherein the control section stores the previous incoming call receiving mode identifier in a memory prior to switching to the vibration mode and retrieves the stored previous incoming call mode identifier from the memory when switching to the previous incoming call receiving mode.

10. The apparatus as claimed in claim 8, wherein the low power RF source is at least one low power RF signal transmitting device installed at entrance and exit locations and the data received in the low power RF signals is received from a corresponding one of the low power RF signal transmitting devices, said data instructing the mobile terminal to switch between the vibration mode and the previous incoming call receiving mode according to the location of the corresponding one of the low power RF signal transmitting devices.
